(19) United States
(12) Patent Application Publication
(10) Pub. No.: US 2010/0299626 A1
(43) Pub. Date: Nov. 25, 2010

(54) Systems and Methods of Providing Rich User Interface and Animation to Auxiliary Display Devices

(75) Inventors: Sachin Hegde, Bellevue, WA (US); Teague Curtiss Mapes, Woodinville, WA (US); Ross Luengen, Sammamish, WA (US); Richard James Swaney, Sammamish, WA (US); Jen-Hung Ho, Redmond, WA (US); Chibong Chan, Kirkland, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/469,463

(22) Filed: May 20, 2009

(51) Int. Cl. G06F 3/01

(52) U.S. Cl. 715/781; 715/764

(57) ABSTRACT

Systems and methods of providing rich user interface (UI) and/or animation from a main computing device to an auxiliary display device (ADD) are disclosed. A renderer driver may be communicatively coupled to the ADD and to an application at the main computing device that provides rich UI or animation. The renderer driver may use one or more interfaces in a renderer library to create a bitmap of the rich UI content/animation in a hidden window and communicate the bitmap to the ADD. For rendering animation at the ADD, updated bitmaps may be repeatedly generated and communicated. The renderer driver may receive an indication of a user input received at the ADD in response to the bitmap, interpret the indication, and communicate to the application the corresponding user response. Some or all portions of the system may reside at the auxiliary device, the main computing device, or both devices.

### BACKGROUND

An auxiliary display device may be in communication with a main computing device. The auxiliary display device may display various types of information from the main computing device, even while the main computing device is powered down. The auxiliary display device may be physically separate from or physically integrated into the main computing device, but in either case, the auxiliary display device may have its own processor and does not need to rely on the main computing device for performing processing tasks or operations. The auxiliary display device may communicate with the main computing device via a wired or wireless connection.

Different applications on the main computing device may communicate information to the auxiliary display device for display. Typically, the auxiliary display device may be simpler than the main computing device, so the auxiliary display device generally does not support sophisticated animation and other rich user interface (UI) rendering technologies available at the main computing device. Thus, the auxiliary display device may display only static text and/or static images.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Embodiments of a system for providing rich user interface (UI) content or animation from a main computing device to an auxiliary display device (ADD) are disclosed. In one embodiment, the system may include a renderer driver coupled to the auxiliary display device and to an application residing on the main computing device. The application may provide or generate rich UI content or animation. The renderer driver may use one or more interfaces contained in a renderer library to create a bitmap image of the rich UI content or animation in a hidden window. The renderer driver may use the same or different interfaces provided by the renderer library to communicate the bitmap image to the auxiliary display device for display. Updated bitmaps may be repeatedly generated and communicated or sent to the ADD to render displayed animation at the ADD.

The renderer driver may receive an indication of a user input received at the auxiliary display device in response to the displayed bitmap. The renderer driver may interpret the indication by applying the indication to the bitmap in the hidden window, and communicate a corresponding user response to the application.

Some or all portions of the system may be located at the main computing device, the auxiliary display device, or at both devices.

Embodiments of a method for providing rich UI content or animation from a main computing device to an auxiliary display device are disclosed. The method may include communicatively coupling a renderer driver to the auxiliary display device, to an application providing the rich UI content or animation, and to a renderer library. The method may receive rich UI content or animation to be displayed at the auxiliary display device, generate a bitmap of the rich UI content/animation in a hidden window, and communicate the bitmap to the auxiliary display device for display. The method may repeatedly generate and communicate an updated bitmap to the auxiliary display device. Some or all portions of the method may be performed by using one or more interfaces provided by the renderer library.

Embodiments of a method for translating a user input received at an auxiliary display device are disclosed. The method may receive an indication of the user input, apply the indication to a bitmap in a hidden window, translate the indication to a corresponding user response, and provide the corresponding user response to an application.

### DRAWINGS

FIG. 1 illustrates an exemplary block diagram of a general purpose computing device;

FIG. 2 depicts an embodiment of a system for providing a rich user interface or animation at an auxiliary display device;

FIG. 3 is an embodiment of a method of providing animation at an auxiliary display device; and

FIG. 4 is an embodiment of a method of translating or interpreting a user input received at an auxiliary display device.

### DETAILED DESCRIPTION

Although the following text sets forth a detailed description of numerous different embodiments, it should be understood that the legal scope of the description is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

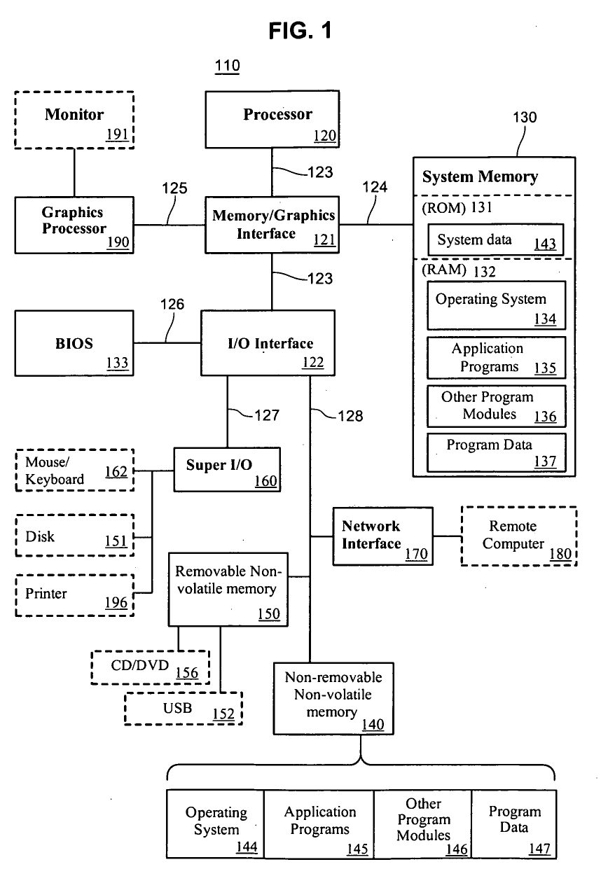

With reference to FIG. 1, an exemplary system for implementing the claimed method and apparatus includes a general purpose computing device in the form of a computer 110. Components shown in dashed outline are not technically part of the computer 110, but are used to illustrate the exemplary embodiment of FIG. 1. Components of computer 110 may include, but are not limited to, a processor 120, a system memory 130, a memory/graphics interface 121, also known as a Northbridge chip, and an I/O interface 122, also known as a Southbridge chip. The system memory 130 and a graphics processor 190 may be coupled to the memory/graphics interface 121. A monitor 191 or other graphic output device may be coupled to the graphics processor 190.

A series of system busses may couple various system components including a high speed system bus 123 between the processor 120, the memory/graphics interface 121 and the I/O interface 122, a front-side bus 124 between the memory/graphics interface 121 and the system memory 130, and an advanced graphics processing (AGP) bus 125 between the memory/graphics interface 121 and the graphics processor 190. The system bus 123 may be any of several types of bus structures including, by way of example, and not limitation, such architectures include Industry Standard Architecture (ISA) bus, Micro Channel Architecture (MCA) bus and Enhanced ISA (EISA) bus. As system architectures evolve, other bus architectures and chip sets may be used but often generally follow this pattern. For example, companies such as Intel and AMD support the Intel Hub Architecture (IHA) and the Hypertransport architecture, respectively.

The computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. The system ROM 131 may contain permanent system data 143, such as identifying and manufacturing information. In some embodiments, a basic input/output system (BIOS) may also be stored in system ROM 131. RAM 132 typically contains data and/or program modules that are immediately accessible to and/or presently being operated on by processor 120. By way of example, and not limitation, FIG. 1 illustrates operating system 134, application programs 135, other program modules 136, and program data 137.

The I/O interface 122 may couple the system bus 123 with a number of other busses 126, 127 and 128 that couple a variety of internal and external devices to the computer 110. A serial peripheral interface (SPI) bus 126 may connect to a basic input/output system (BIOS) memory 133 containing the basic routines that help to transfer information between elements within computer 110, such as during start-up.

A super input/output chip 160 may be used to connect to a number of ‘legacy’ peripherals, such as read/writeable disk 151, keyboard/mouse 162, and printer 196, as examples. The super I/O chip 160 may be connected to the I/O interface 121 with a low pin count (LPC) bus, in some embodiments. The super I/O chip 160 is widely available in the commercial marketplace.

In one embodiment, bus 128 may be a Peripheral Component Interconnect (PCI) bus, or a variation thereof, may be used to connect higher speed peripherals to the I/O interface 122. A PCI bus may also be known as a Mezzanine bus. Variations of the PCI bus include the Peripheral Component Interconnect-Express (PCI-E) and the Peripheral Component Interconnect-Extended (PCI-X) busses, the former having a serial interface and the latter being a backward compatible parallel interface. In other embodiments, bus 128 may be an advanced technology attachment (ATA) bus, in the form of a serial ATA bus (SATA) or parallel ATA (PATA).

The computer 110 may also include other removable/non-removable, volatile/nonvolatile computer storage media. By way of example only, FIG. 1 illustrates a hard disk drive 140 that reads from or writes to non-removable, nonvolatile magnetic media. Removable media, such as a universal serial bus (USB) memory 152 or CD/DVD drive 156 may be connected to the PCI bus 128 directly or through an interface 150. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like.

The drives and their associated computer storage media discussed above and illustrated in FIG. 1, provide storage of computer readable instructions, data structures, program modules and other data for the computer 110. In FIG. 1, for example, hard disk drive 140 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a mouse/keyboard 162 or other input device combination. Other input devices (not shown) may include a microphone, joystick, game pad, satellite dish, scanner, or the like. These and other input devices are often connected to the processing unit 120 through one of the I/O interface busses, such as the SPI 126, the LPC 127, or the PCI 128, but other busses may be used. In some embodiments, other devices may be coupled to parallel ports, infrared interfaces, game ports, and the like (not depicted), via the super I/O chip 160.

The computer 110 may operate in a networked environment using logical connections to one or more remote computers, such as a remote computer 180 via a network interface controller (NIC) 170. The remote computer 180 may be a personal computer, a server, a router, a network PC, a peer device or other common network node, and typically includes many or all of the elements described above relative to the computer 110. The logical connection between the NIC 170 and the remote computer 180 depicted in FIG. 1 may include a local area network (LAN), a wide area network (WAN), or both, but may also include other networks. Networks may be wireless, wired, or a combination of the two. Such networking environments are commonplace in offices, enterprise-wide computer networks, intranets, and the Internet.

Computing device 110 may encompass many different computing device configurations. For example, computing device 110 may realized in hand-held devices, mobile phones, multi-processor systems, microprocessor-based or programmable consumer electronics, network PCs, minicomputers, mainframe computers, portable computing or communication devices, and or other computing device capable of both visual display and direct or indirect communication with another computing device.

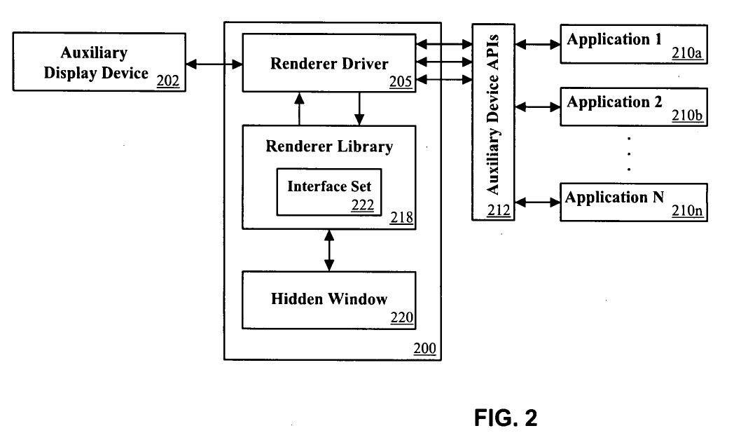

FIG. 2 depicts an embodiment of a system 200 for providing a rich user interface (UI) or animation at an auxiliary display device (ADD) 202. The system 200 may operate in conjunction with embodiments of the computing device 110 of FIG. 1. The rich UI may include features commonly available on a desktop user interface. For example, the rich user interface may include animation, modification or orientation of images, embedded HTML links or hyperlinks, media, multimedia, plug-ins, and other such features commonly available and known as able to be provided by a rich user interface.

The auxiliary display device 202 may be any auxiliary display device known in the art. Generally, an auxiliary display device 202 may be in communication with a main computing entity to display and access information from the main computing entity, even if the main computing entity is powered down. Also, the ADD 202 may have its own separate processor from the main computing entity and may not rely on the main computing entity for processing tasks. Some types of auxiliary display devices 202 may be physically integrated with the main computing entity, such as, for example, a display embedded on the side or the top of a personal computer. An integrated auxiliary display device 202 may obtain power from the personal computer, but in such a small amount that the auxiliary display device may be fully operational even though the personal computer is powered down or in stand-by mode. Possible information from the personal computer that may be displayed by the auxiliary device may include contents of an electronic mailbox, an appointment calendar, maps or directions, to name a few.

Other types of auxiliary display devices 202 may be physically separate from the main computing entity. A separate auxiliary display device 202 may communicate with the main computing entity over a wired or a wireless connection. Examples of separate auxiliary display devices 202 may include cell phones or wireless smart devices, remote controls, digital picture frames, diagnostic equipment, electronic readers, and others. Thus, additional examples of possible information from the main computing entity to be displayed on an auxiliary display device 202 may include digital pictures, electronic books, home automation information, program guides, and others.

In the system 200, the ADD 202 may be in wired or wireless communication with a renderer driver 205. The renderer driver 205 may serve as the “traffic cop” of the system and may coordinate the display of information from a main computing device (not shown) at the ADD 202. Accordingly, the renderer driver 205 may be in wired or wireless communication with at least one application 210a-210n that has or generates rich user interface (UI) information to be displayed at the auxiliary display device 202. The applications 210a-210n may reside on the main computing entity with which the auxiliary display device 202 is in communication. Typically, but not necessarily, the applications 210a-210n may communicate with the renderer driver 205 via one or more auxiliary display application program interfaces (APIs) 212. Applications 210a-210n may typically (but not necessarily) be light-weight, single purpose applications. Examples of applications 210a-210n may include clocks, calendars, RSS notifiers, search tools, stock charts, weather reports, slide shows, games, and the like.

The renderer driver 205 may perform its responsibilities in conjunction with a renderer library 218 of the system 200. The renderer library 218 may include a set of interfaces 222, each of which may perform one or more discrete functions or tasks necessary to enable rich UI content to be displayed at the auxiliary display device 202. Some or all of the interfaces 222 may be exposed for use by the applications 210a-210n. Some or all of the interfaces 222 may be reserved for use only by the renderer driver 205. The set of interfaces 222 may be, for example, a set of application program interfaces, schemas, objects, or any other types of interfaces used in by languages commonly known in the art.

Consider, for ease of discussion, the application 210a. When the application 210a desires to communicate or send rich UI content information to the auxiliary display device 202, the application 210a may provide the rich UI content information to the renderer driver 205. In some embodiments, the application 210a may provide the rich UI content directly to the renderer driver 205, and in other embodiments, the application 210a may provide the rich UI content to the renderer driver 205 by way of one or more auxiliary display APIs 212. For example, a particular auxiliary display API 212 may provide the rich UI content to a string buffer from which the renderer driver 205 may retrieve the rich UI content, or a different auxiliary display API 212 may provide the rich UI content in a string buffer directly to the renderer driver 205.

The renderer driver 205 may receive (or in some embodiments, retrieve) the rich UI content by using an interface 222 provided by the renderer library 218. Upon receiving the rich UI content, the renderer driver 205 may use the same or a different interface 222 provided by the library 218 to render or generate a bitmap image of the rich UI information content in a hidden window 220 of the system 200. The renderer driver 205 may then invoke the same or a different interface 222 from the renderer library 218 to communicate or send the bitmap image to the ADD 202 for display. In some embodiments, the hidden window 220 may be created in the system 200 each time a bitmap needs to be rendered. In some embodiments, a different hidden window 220 may be created for each specific application 210a-210n. In other embodiments, the hidden window 220 may be globally allocated or otherwise available a priori.

At a pre-determined time interval, the renderer driver 205 may generate an updated bitmap image of the rich UI information content in the hidden window 220 and may communicate or send the updated bitmap image to the auxiliary display device 202. The updated bitmap image may be generated and communicated, for example, when the rich UI information content changes. Thus, updated snapshots of rich UI content or animation may be repeatedly generated and communicated to the auxiliary display device for display as the rich UI content or animation changes. Alternatively or additionally, the updated bitmap image may be repeatedly generated and communicated at fixed time intervals independent of any changes to the content. The pre-determined time interval may be selected, and a duration of the predetermined time interval may vary from application to application 210a-210n. In this manner, animation may be displayed at the ADD 202 via a series of updated bitmap images transmitted at intervals from the renderer driver 205 to the auxiliary display device 202. In addition, video encoding such as MPEG, MPEG2, PMEG4, A VI, JPEG, etc., may be used to assist in compressing the bitmap images.

The ADD 202 may have a capability of receiving a user input, such as via a mouse click, a touch screen selection, or other means. Sometime after the renderer driver 205 has generated a specific bitmap image in the hidden window 220 and has communicated the specific bitmap image to the ADD 202, the ADD 202 may communicate or send to the renderer driver 205 an indication of a received user input in response to the displayed specific bitmap image. In one embodiment, the indication of the received user input may be in a bitmap format. The renderer driver 205 may apply the bitmap corresponding to the received user input to the specific bitmap image in the hidden window 220 to determine a particular location or an element on the display corresponding to the received user input. Based on the determination of the particular location or display element, the renderer driver 205 may interpret and communicate a corresponding, contextual received user response to the application 210a.

The system 200 provides a simple, elegant solution for enabling rich UI content and/or animation from a main computing device to be displayed at an auxiliary display device 202. Main computing devices generally support sophisticated rich UI interface or animation technologies, such as XAML (Extensible Application Markup Language), WPF (Windows Presentation Foundation), Javascript, and the like. Auxiliary display devices, however, are typically simpler devices, use significantly less power, and thus do not support these sophisticated technologies. Generally, an available auxiliary display device 202 receives information to be displayed from the main computing entity in SCF (Simple Content Format) or bitmap images. Neither SCF nor bitmap images are rich or robust enough to include animation or other rich UI content. The present disclosure presents a simple, elegant solution for providing animation and rich UI information at an auxiliary display device 202 without requiring changes to the protocol understood by the auxiliary display device 202 or changes to the auxiliary display device 202 itself. This characteristic is especially important as auxiliary display devices may be provided by a multitude of different vendors and may have a significantly-sized embedded market presence. The present disclosure enables animation and rich UI interfaces to be seamlessly and easily provided for display to any auxiliary display device in the market.

Turning now to the set of interfaces 222 provided by the renderer library 218, the set of interfaces 222 may include an interface for rendering a bitmap, such as when the renderer driver 205 generates a bitmap corresponding to rich user interface content or animation in the hidden window 220.

The set of interfaces 222 may include a interface for updating a user interface element based on user input received at the ADD 202. The renderer driver 205 may receive an indication of a user input reflecting an update to a user interface element on a display represented by a bitmap image communicated to the ADD 202. For example, the update to the user interface element may indicate a deletion of characters or a re-sizing somewhere on the display represented by the bitmap image.

The set of interfaces 222 may include an interface to clear contents of the hidden window 220, such as when an updated bitmap needs to be generated.

The set of interfaces 222 may include an interface for indicating a user selection based on user input received at the ADD 202. The renderer driver 205 may receive an indication of a user input reflecting a user selection of an element on the display represented by the bitmap image communicated to the ADD 202. The user selection may indicate a received mouse click, a touch selection, or other means of selection.

The set of interfaces 222 may include an interface for creating the hidden window 220 and an interface for communicating a generated bitmap to the auxiliary display device 202. Typically (but not necessarily), the interface for creating the hidden window 220 and the interface for communicating a generated bitmap may be used by the renderer driver 205. In fact, in some embodiments, a first group of interfaces from the set of interfaces 222 may be reserved for use exclusively by the renderer driver 205. A second group of interfaces from the set of interfaces may be exposed, for example, for use by one or more applications 210a-210n. The first and the second group of interfaces may or may not be equivalent.

Of course, the partitioning of various tasks and functions across different interfaces 222 discussed herein is exemplary only. In some embodiments, various functions or tasks provided by the renderer library 218 may be partitioned into any combination of interfaces 222. For example, a single interface may both clear the hidden window 220 and generate a new bitmap. Or, a different single interface may both generate the new bitmap and communicate or send the new bitmap to the ADD 202. Other combinations may be possible.

Additionally, the system 200 or parts thereof may be distributed across multiple entities. For example, in some embodiments, the system 200 may entirely reside at the main computing device with which the auxiliary display device 202 communicates. In other embodiments, such as when the auxiliary display device 202 is more sophisticated, the system 200 may entirely reside at the auxiliary display device 202. In other embodiments, the system 200 may be distributed across multiple entities, such as the renderer driver 205 being located at the main computing device but the renderer library 218 and the hidden window 220 begin located at the ADD 202. Embodiments where some or all portions of the system 200 reside at the auxiliary display device 202 may minimize a data transfer load across a communication channel between the main computing device and the auxiliary display device 202.

In an exemplary embodiment, a single instance of the renderer driver 205 may correspond to a given auxiliary display device 202. In other embodiments, a single instance of renderer driver 205 may correspond to more than one auxiliary display device 202.

The system 200 may support receiving rich UI and/or animation content in any language in which rich UI and/or animation content may be rendered, such as JavaScript, AJAX (Asynchronous JavaScript and XML (Extensible Markup Language)), CSS (Cascading Style Sheets), XAML (Extensible Application Markup Language), and others. Consider an example where an embodiment of the system 200 supports XAML rich UI or animation content and the application 210b is a WPF (Windows Presentation Foundation) application that generates XAML content for display. The renderer library 218 may include an interface 222 for creating an XAML endpoint with which the application 210b may register. The registered application 210b may use an auxiliary display API 212 to provide XAML content in a string buffer to the renderer driver 205. The renderer driver 205 may then use one or more interfaces 222 in the renderer library 218 to render bitmaps in the hidden window 220 based on the XAML content in the string buffer and communicate or send the bitmaps to the ADD 202. The renderer driver 205 may also use one or more interfaces 222 provided by the renderer library 218 to interpret received user inputs received from the ADD 202 and trigger corresponding events on the XAML content file.

In one possible implementation, the renderer library 218 may include exposed interfaces including a render bitmap interface, an updated user element interface, a clear or kill rendered bitmap interface and a user selection interface as follows:

```
[ComVisible(true)]
  [InterfaceType(ComInterfaceType.InterfaceIsIUnknown)]
  [Guid(“CEDA0682-F902-4810-92AF-F737FD4BB9D5”)]
  public interface IXAMLRenderer
  {
    void RegisterDisplayBitmap(IDisplayBitmap displayBitmap);
    void RenderXamlBuffer(
      [MarshalAs(UnmanagedType.LPArray, SizeParamIndex=1)]
      byte[ ] pbData,
      uint cbDataSize
      );
    void UpdateUIElement(
      [MarshalAs(UnmanagedType.LPWStr)]
      string elementname,
      [MarshalAs(UnmanagedType.LPWStr)]
      string property,
      [MarshalAs(UnmanagedType.LPWStr)]
      string value
      );
    void KillRendering( );
    void MouseClickEvent(long coordX, long coordY, bool mousedown);
  }
```

A possible implementation by which the XAML renderer library 218 may create a hidden window 220 and may render XAML content in the hidden window 220 may be as follows:

```
private static FrameworkElement s_rootElement;
public void RenderXamlBuffer(byte[ ] bXAMLBuffer, uint cbDataSize)
{
      using (MemoryStream ms = new MemoryStream(bXAMLBuffer))
    {
        s_rootElement = XamlReader.Load(ms) as FrameworkElement;
        s_rootElement.AddHandler(Button.ClickEvent, new
RoutedEventHandler(OnClickHandler));
        if (s_rootElement != null)
        {
          HwndSourceParameters hwndParameters = new HwndSourceParameters( );
          hwndParameters.Width = 800;
          hwndParameters.Height = 240;
          hwndParameters.WindowName = “XamlRenderWindow”;
          HwndSource source = new HwndSource(hwndParameters);
          VisualBrush vb = new VisualBrush( );
          vb.Stretch = Stretch.None;
          vb.Changed += delegate(object sender, EventArgs e)
          {
            // called whenever there is a change in UI
            RenderTargetBitmap renderBitmap = new
RenderTargetBitmap(hwndParameters.Width, hwndParameters.Height, 96, 96,
PixelFormats.Pbgra32);
            renderBitmap.Render(s_rootElement);
                // Send or Communicate the Bitmap down to the device
            ((CXamlRenderer)param).SendBitmap(renderBitmap);
          };
          CompositionTarget.Rendering += delegate(object sender, EventArgs e)
          {
          };
          Grid xaml_grid = new Grid( );
          xaml_grid.Children.Add(s_rootElement);
          NameScope nameScope = new NameScope( );
          NameScope.SetNameScope(xaml_grid, nameScope);
          xaml_grid.RegisterName(“ReflectedVisual”, s_rootElement);
          Rectangle rect = new Rectangle( );
          rect.Fill = vb;
          Binding reflectionBinding = new Binding( );
          reflectionBinding.ElementName = “ReflectedVisual”;
          BindingOperations.SetBinding(vb, VisualBrush.VisualProperty,
reflectionBinding);
          xaml_grid.Children.Add(rect);
          source.RootVisual = xaml_grid;
          vb.Visual = s_rootElement;
          s_renderFrame = new DispatcherFrame(true);
          Dispatcher.PushFrame(s_renderFrame);
        }
      }
    }
```

A possible implementation for creating a bitmap and communicating or sending the bitmap to the auxiliary display device 202 when a new user interface is rendered may be as follows:

```
    /// <summary>
    /// Function which calls back into the unmanaged code with
the bitmap written to memory
    /// </summary>
    /// <param name=“bitmap”></param>
    unsafe public void SendBitmap(BitmapSource bitmap)
    {
      if (m_displayBitmap != null)
      {
        using (MemoryStream stream = new MemoryStream( ))
        {
          System.Windows.Media.Imaging.BmpBitmapEncoder
encoder = new BmpBitmapEncoder( );
          encoder.Frames.Add(BitmapFrame.Create(bitmap));
          encoder.Save(stream);
          int length = (int)stream.Length;
          byte[ ] byteStream = stream.ToArray( );
          if (s_prevBlockSize == 0)
          {
            // previous block not allocated
            s_pMem = Marshal.AllocCoTaskMem(length);
            s_prevBlockSize = length;
          }
          else if( s_prevBlockSize < length)
          {
            // previous block is smaller then required
            s_pMem = Marshal.ReAllocCoTaskMem(s_pMem,
            length);
            s_prevBlockSize = length;
          }
          int pintIndex = 0;
          foreach (byte b in byteStream)
          {
            Marshal.WriteByte(s_pMem, pintIndex, b);
            pintIndex++;
          }
          UInt64 addr = (UInt64)s_pMem;
          m_displayBitmap.OnDisplayBitmap(addr, length);
        }
      }
    }
```

A possible implementation of an interface that the rendering driver 205 may implement to interact with the renderer library 218 may be as follows:

```
[Com Visible(true)]
  [InterfaceType(ComInterfaceType.InterfaceIsIUnknown)]
  [Guid(“517DD526-A060-4c5a-9DFC-0FD7D75810D6”)]
  public interface IDisplayBitmap
  {
    unsafe void OnDisplayBitmap(
    [In, Out , MarshalAs(UnmanagedType.U8 )]
      UInt64 addr,
    int cbDataSize);
  void OnXAMLEvent(
    [In, MarshalAs(UnmanagedType.LPWStr)]
    string wszName,
    int wszNameLen,
    int eventtype,
    int listboxindex
    );
  }
```

Note that in the above example, the OnDisplayBitmap function may be called from the renderer library 218 with a rendered bitmap. The renderer driver 205 may then communicate or send this bitmap to the auxiliary display device 202 using one or more available auxiliary display APIs 212.

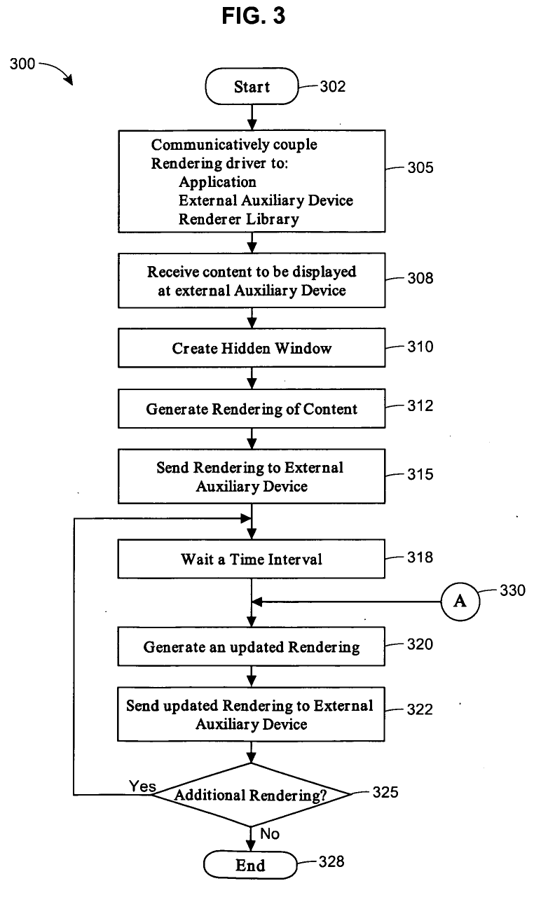

FIG. 3 is an embodiment of a method 300 of providing animation at an auxiliary display device. The method 300 may operate in conjunction with embodiments of the computing device 110 of FIG. 1 and the system 200 of FIG. 2.

At the start 302 of the method 300, a rendering driver may be communicatively coupled 305 to an application of a main computing device, an auxiliary display device (ADD) and a renderer library. The application may have or may generate rich user interface content or animation for display at the ADD. Each of the communicative couplings may be a direct coupling, such as when both ends of the coupling reside on a same computing device. Each of the communicative couplings may be a wired or a wireless coupling. In fact, any known method and/or mean of communicative coupling may be used in accordance with the method 300.

At block 308, animation content to be displayed at the auxiliary display device may be received from the application. The animation content may be received from the application via a message, a buffer, an application program interface, or via some other means.

At block 310, a hidden window may be created. In some embodiments of the method 300, the block 310 may be optional, such as if a hidden window is pre-defined or globally allocated in a memory.

At block 312, a bitmap of the animation content may be rendered or generated in the hidden window.

At block 315, the bitmap may be communicated or sent to the ADD.

At block 318, a time interval may pass. A duration of the time interval may be pre-selected, and may vary from one application to another. Alternatively or additionally, the duration of the time interval may be based on a change to the display content itself.

At block 320, an updated bitmap of the animation content may be rendered or generated in the hidden window, and at block 322, the updated bitmap may be communicated or sent to the ADD.

At block 325, a determination of whether or not additional animation is desired to be communicated to the auxiliary display device may be made. If more animation is desired to be displayed at the auxiliary display device, the method 300 may return to the block 318 to wait for the prescribed time interval to pass, and subsequent updated bitmaps may be generated 320 and communicated or sent 322 to the ADD. Thus, by selecting an appropriate time interval to wait at the block 318, a series of updated bitmaps displayed at the auxiliary display device may appear as animated content generated by the application.

If no more animation is desired as determined at the block 325, then the method 300 may end 328.

Some or all of the blocks of the method 300 may be performed by the renderer driver. Some or all of the blocks of the method 300 may be performed using one or more interfaces provided by the renderer library.

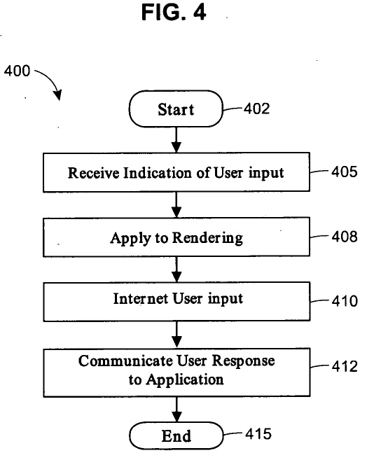

FIG. 4 is an embodiment of a method 400 of translating a user input received at an auxiliary display device. The method 400 may operate in conjunction with embodiments of the computing device 110 of FIG. 1, the system 200 of FIG. 2 and the method 300 of FIG. 3.

In an exemplary embodiment, the method 400 may execute at point A (reference 330) between the block 318 and the block 320 of the method 300. Thus, the method 400 may be performed after a bitmap has been communicated or sent 315 for display at the ADD and a time interval of waiting has not entirely passed. In particular, the method 400 may be performed after a user input is received at the auxiliary display device in response to the displayed bitmap. For example, a user may make a selection at the ADD on the display represented by the displayed bitmap, such as making a selection via a mouse click, touch selection, or other selection means. Or, in another example, the user may update a user interface element on the display represented by the displayed bitmap, such as resizing the user interface element, deleting or adding text to the user interface element, or some other type of update.

At the start 402 of the method 400, an indication of the user input at the auxiliary display device may be received 405, for example, in a bitmap format at the renderer driver. The indication of the user input may be applied to the bitmap in the hidden window 408. Based on the application to the bitmap, a location, a display element and/or an action corresponding to the user input may be determined, translated or interpreted 410. A corresponding user input or contextual response may then be communicated 412 to the application in a manner or format familiar to the application.

Consider the example of the WPF application 210b rendering XAML animation content previously discussed with respect to FIG. 2, and currently discussed with respect to the method 400. The method 400 may receive the indication of the user input 405 and may apply the indication to the bitmap in the hidden window 408. Specifically, the received indication may be mapped to a specific location on the bitmap, or to a specific user interface element on the display represented by the bitmap. The specific location and/or the specific user interface element may then be interpreted 410, and a corresponding event may be triggered 412 in the corresponding XAML animation content or file corresponding to the WPF application 210b.

Finally, at the block 415, the method 400 may end.

Although the foregoing text sets forth a detailed description of numerous different embodiments, it should be understood that the scope of the patent is defined by the words of the claims set forth at the end of this patent. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims.

Thus, many modifications and variations may be made in the techniques and structures described and illustrated herein without departing from the spirit and scope of the present claims. Accordingly, it should be understood that the methods and apparatus described herein are illustrative only and are not limiting upon the scope of the claims.

What is claimed:

1. A system for providing a rich user interface at an auxiliary display device coupled to a computer, comprising:
an application executing on the computer;
a renderer driver communicatively coupled to both the application and the auxiliary display device and configured to receive a rich user interface (UI) display content from the application;
a renderer library communicatively coupled to the renderer driver and exposing a set of interfaces; and
a hidden window communicatively coupled to the renderer library,
wherein the renderer driver is configured to use at least one interface from the set of interfaces in the renderer library to:
create, in the hidden window, a bitmap of the rich UI display content, and
communicate the bitmap to the auxiliary display device for display.

2. The system of claim 1, wherein the renderer library resides on the computer.

3. The system of claim 1, wherein the renderer library resides on the auxiliary display device.

4. The system of claim 1, wherein the application is an animation application and the renderer driver is further configured to, at a selected interval, generate in the hidden window an updated bitmap of the rich UI display content and communicate the updated bitmap to the auxiliary display device.

5. The system of claim 4, wherein a duration of the selected interval is based on at least one of: a change to the rich UI display content or a user selection.

6. The system of claim 1, wherein the rich UI display content comprises one of XAML (Extensible Application Markup Language), JavaScript, AJAX (Asynchronous JavaScript and XML (Extensible Markup Language)), CSS (Cascading Style Sheets) content.

7. The system of claim 1, wherein the rich UI display content is received in a string buffer.

8. The system of claim 1, wherein the rich UI display content includes at least one of: an animation, a hyperlink, a modification of an image, media content or multimedia content.

9. The system of claim 1, wherein the renderer driver is further configured to use at least one other interface of the set of interfaces in the renderer library to:
receive, from the auxiliary display device, an indication of a user input generated at the auxiliary display device in response to the bitmap;
apply the indication of the user input to the bitmap in the hidden window; and
communicate a translation of the indication of the user input to the application.

10. The system of claim 1, wherein a portion of the set of interfaces are exposed by the renderer library, the portion including a render bitmap interface, an update user interface element interface, a clear rendered bitmap interface, and a user selection event interface.

11. The method of claim 1, wherein the renderer library includes a separate interface for at least one of: registering the application with an endpoint, creating the hidden window, or communicating a particular bitmap to the auxiliary display device.

12. A method of providing animation at an auxiliary display device coupled to a computer, comprising:
communicatively coupling a rendering driver to an application executing on the computer, to the auxiliary display device and to a renderer library, the renderer library including a set of application interfaces;
receiving animation content from the application;
creating, via a first application interface from the set of application interfaces, a hidden window;
generating, in the hidden window via a second application interface from the set of application interfaces, a first bitmap of the animation content;
communicating, via a third application interface from the set of application interfaces, the first bitmap to the auxiliary display device for display;
clearing, via a fourth application interface from the set of application interfaces, the first bitmap from the hidden window;
generating, in the hidden window via the second application interface, a second bitmap of the animation content; and
communicating, via the third application interface, the second bitmap to the auxiliary display device for display,
wherein communicating the second bitmap is performed at a pre-determined time interval after communicating the first bitmap and a duration of the pre-determined time interval based on at least one of: a user selection or a change to the animation content.

13. The method of claim 12, further comprising exposing at least a portion of the set of application interfaces to the application.

14. The method of claim 12, further comprising at the rendering driver:
receiving, from the auxiliary display device via a fifth interface from the set of application interfaces, an indication of a user response corresponding to the first bitmap;
applying, via a sixth interface from the set of application interfaces, the indication of the user response to the first bitmap in the hidden window;
communicating to the application, via a seventh interface from the set of application interfaces, a translation of the indication of the user response.

15. The method of claim 12, further comprising creating an XAML (Extensible Markup Language) endpoint, and wherein receiving the animation content from the application comprises receiving XAML content from the application wherein the application is registered with the XAML endpoint.

16. The method of claim 12, wherein communicatively coupling the rendering driver to the renderer library comprises communicatively coupling the rendering driver to a renderer library resident on the computer.

17. The method of claim 12, wherein communicatively coupling the rendering driver to the renderer library comprises communicatively coupling the rendering driver to a renderer library resident on the auxiliary display device.

18. A computer-readable storage medium having thereon computer-executable instructions for providing animation at an auxiliary display device coupled to a computer, comprising computer-executable instructions for:
exposing at least a portion of a set of interfaces in a renderer library, the set of interfaces for providing the animation at the auxiliary display device;
creating an endpoint for XAML (Extensible Markup Language) with which an application executing on the computer registers, the application enabled to generate XAML content for display on the auxiliary display device; and
at a driver corresponding to the auxiliary display device and communicatively coupled to the renderer library and to the application, using at least one interface from the set of interfaces in the renderer library to:
create a hidden window;
retrieve, from a string buffer, the XAML content generated by the application;
generate a first bitmap of the XAML content in the hidden window;
communicate the first bitmap to the auxiliary display device for display;
after a pre-determined time interval, generate a second bitmap of the XAML content in the hidden window, the pre-determined time interval based on at least one of a change to the XAML content or a user selection; and
communicate the second bitmap to the auxiliary display device for display.

19. The computer-readable storage medium of claim 18, further comprising using, at the driver, at least one other interface from the set of interfaces in the renderer library to:
receive, from the auxiliary display device, an indication of a user input in response to the first bitmap;
apply the indication of the user input to the first bitmap in the hidden window; and
trigger an event on the XAML content, the event corresponding to the user input.

20. The computer-readable storage medium of claim 18, further comprising computer-executable instructions for executing the renderer library on at least one of the auxiliary display device or the computer.
